(19) United States
(12) Patent Application Publication
(10) Pub. No.: US 2016/0277698 A1
(43) Pub. Date: Sep. 22, 2016

(54) METHOD FOR VOCALLY CONTROLLING A TELEVISION AND TELEVISION THEREOF

(71) Applicants: BOE TECHNOLOGY GROUP CO., LTD., Beijing (CN); BEIJING BOE DISPLAY TECHNOLOGY CO., LTD., Beijing (CN)

(72) Inventors: Hailong WU, Beijing (CN); Juan YU, Beijing (CN); Weitao CHEN, Beijing (CN)

(21) Appl. No.: 14/436,304

(22) PCT Filed: Aug. 27, 2014
(86) PCT No.: PCT/CN2014/085329

§ 371 Date: Apr. 16, 2015

(30) Foreign Application Priority Data
Mar. 14, 2014 (CN) 201410095779.X

(51) Int. Cl. H04N 5/44; G10L 15/22; G10L 15/07; H04N 21/422

(52) U.S. Cl. CPC H04N 5/4403; H04N 21/42203; G10L 15/22; G10L 15/07; H04N 2005/4432; G10L 2015/223

(57) ABSTRACT

A method for vocally controlling a television and television thereof is provided. The method for vocally controlling a television comprises collecting a first voice signal of a user; displaying an instruction interface which comprises N instructions for the user to select a first instruction corresponding to the first voice signal when the television cannot recognize the first voice signal, said first instruction being any one instruction among the N instructions; and storing the first voice signal in a first voice set corresponding to the first instruction according to the pre-built instruction-voice set correspondence relationship, the first voice set comprising all the voice signals for triggering the first instruction. The method for vocally controlling a television and the television of the present disclosure can improve the voice control function of the television.

### TECHNICAL FIELD OF THE DISCLOSURE

The present disclosure relates to a method for vocally controlling a television and television thereof.

### BACKGROUND

Voice is the most direct way for a human to naturally express himself. Voice recognition is considered as the main development direction of human-computer interaction. With development of voice recognition technologies and wide use of televisions, more and more televisions use voice recognition technologies to perform voice control. The known voice recognition for televisions is to perform coding process on the collected user voice signal, then extract voice features (such as sound frequency, sound pressure and so on) in the voice signal after being coded, and finally compare the extracted voice features with a pre-stored voice template to determine whether to execute a corresponding instruction based on the comparison result.

The known voice recognition technologies can only recognize voice signals of which the language is the same as that of the pre-stored voice template, or fuzzily query voice signals with a similar language. However, in practical applications, the situation in which the user's language is not the same as or even not similar to that of the pre-stored voice template can usually occur. For example, China is a multinational country, and there are many dialects. If the voice template is Mandarin, when a user performs voice control using a dialect, his voice may not be recognized. Some foreigners living in China cannot effectively use television voice control function either.

### SUMMARY

Embodiments of the present disclosure provide a method for vocally controlling a television and television thereof, which can improve the voice control function of the television.

Embodiments of the present disclosure employ the following technical solutions.

On aspect provides a method for vocally controlling a television, which is used for the television, comprising: collecting a first voice signal of a user; when the television cannot recognize the first voice signal, displaying an instruction interface which comprises N instructions for the user to select a first instruction corresponding to the first voice signal, and said first instruction being any one instruction among the N instructions; and according to the pre-built instruction-voice set correspondence relationship, storing the first voice signal in a first voice set corresponding to the first instruction, the first voice set comprising all the voice signals for triggering the first instruction.

Optionally, before collecting the first voice signal of the user, the method further comprises the following: building the instruction-voice set correspondence relationship for indicating the correspondence relationship among the N instructions and N voice sets such that each of the N instructions is corresponding to one voice set.

Optionally, each of the voice sets comprises a standard voice signal which is generated by recording in standard Mandarin.

Optionally, before collecting the first voice signal of the user, the method further comprises the following: numbering the N instructions such that each of the instructions is corresponding to one number in order for the user to select the instruction corresponding to a number by inputting the number.

One aspect provides a television comprising a collecting unit configured to collect a first voice signal of a user; a display unit configured to display an instruction interface which comprises N instructions for the user to select a first instruction when the television cannot recognize the first voice signal collected by the collecting unit, the first instruction being any one instruction among the N instructions; and a storage unit configured to store the first voice signal collected by the collecting unit in a first voice set corresponding to the first instruction according to the pre-built instruction-voice set correspondence relationship, the first voice set comprising all the voice signals for triggering the first instruction.

Optionally, the television further comprises a building unit configured to build the instruction-voice set correspondence relationship for indicating the correspondence relationship among the N instructions and N voice sets such that each instruction among the N instructions is corresponding to one voice set.

Optionally, each of the voice sets comprises a standard voice signal which is generated by recording in standard Mandarin.

Optionally, the television further comprises a numbering unit configured to number the N instructions such that each of the instructions is corresponding to one number in order for the user to select the instruction corresponding to a number by inputting the number.

The method for vocally controlling a television and television thereof provided by embodiments of the present disclosure first collect a first voice signal of a user, and then determine whether the first voice signal can be recognized. When the television cannot recognize the first voice signal, displaying an instruction interface which comprises N instructions for the user to select a first instruction, said first instruction being any one instruction among the N instructions. After the user selects the first instruction, the first instruction is executed, and the first voice signal is stored in a first voice set corresponding to the first instruction according to the pre-built instruction-voice set correspondence relationship. When the user's voice instruction is the first voice signal next time, the television can recognize that the user needs to perform the operation of the first instruction, and executes the first instruction after the recognition, finishing the user's voice control procedure. Compared with the known technologies, the voice control function of a television is improved.

### BRIEF DESCRIPTION OF THE DRAWINGS

In order to more clearly explain the technical solutions in embodiments of the present disclosure or in the prior art, accompanying figures that need to be used in the description of the embodiments or the prior art will be briefly introduced in the following. Obviously, the figures in the following description are only some embodiments of the present disclosure. Those skilled in the art can obtain other figures based on those accompanying figures without inventive work.

FIG. 1 is a flowchart of a method for vocally controlling a television provided by an embodiment of the present disclosure;

FIG. 2 is a flowchart of another method for vocally controlling a television provided by an embodiment of the present disclosure;

FIG. 3 is a schematic structural diagram of a television provided by an embodiment of the present disclosure;

FIG. 4 is a schematic structural diagram of another television provided by an embodiment of the present disclosure; and

FIG. 5 is a schematic structural diagram of still another television provided by an embodiment of the present disclosure.

### DETAILED DESCRIPTION

Clear and complete description on the technical solutions in embodiments of the present disclosure will be made in connection with figures in the embodiments of the present disclosure in the following. Obviously, the described embodiments are only part but not all of the embodiments of the present disclosure. Based on the embodiments in the present disclosure, all the other embodiments obtained by those skilled in the art without inventive work fall within the protection scope of the present disclosure.

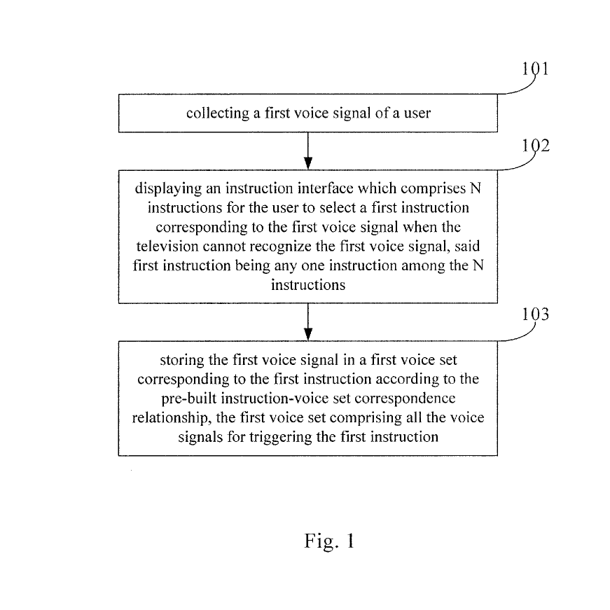

An embodiment of the present disclosure provides a method for vocally controlling a television, and the method is used for the television. As shown in FIG. 1, the method comprises steps 101-103.

At step 101, a first voice signal of a user is collected.

When receiving the user's voice control, the television first needs to receive the user's voice instruction. The voice instruction is the first voice signal that the television needs to collect. Since the voice instruction sent by the user of the television can be any language or any dialect, the first voice signal collected by the television can also be any language or any dialect.

At step 102, when the television cannot recognize the first voice signal, an instruction interface is displayed. The instruction interface comprises N instructions for the user to select a first instruction corresponding to the first voice signal, said first instruction being any one instruction among the N instructions.

For example, after collecting the first voice signal, the television first determines whether the television can recognize the first voice signal. The voice recognition of the first voice signal is the same as the voice recognition process of the known technologies, which will not be repeatedly described in the embodiments of the present disclosure. When the television cannot recognize the first voice signal, the television cannot carry out the user's voice control procedure. At this time, the television displays the instruction interface which can display N instructions. The N instructions are all the executable instructions of the television. In practical applications, the instruction interface can also display M instructions that the user may need and are selected by the television according to the first voice signal, and M is smaller than or equal to N. The user selects the required first instruction from the N instructions displayed by the instruction interface. The first instruction is any one instruction of the N instructions. Normally, the user can use a remote controller to move a to-be-conformed mark to the first instruction, then select the first instruction through a confirm key. Alternatively, it is possible to number all the executable instructions of the television upon initialization, and then the user selects the first instruction by using the number keys of the remote controller to select the number corresponding to the first instruction.

At step 103, according to the pre-built instruction-voice set correspondence relationship, the first voice signal is stored in a first voice set corresponding to the first instruction. The first voice set comprises all the voice signals for triggering the first instruction.

The instruction-voice set correspondence relationship is pre-built for indicating the correspondence relationship among the N instructions and N voice sets such that each instruction among the N instructions is corresponding to one voice set. Each voice set comprises all the voice signals that can trigger the instruction corresponding to the voice set. When the instruction selected by the user is the first instruction, it means the instruction corresponding to the first voice signal collected by the television is the first instruction. The television executes the first instruction, and stores the first voice signal in a first voice set corresponding to the first instruction according to the pre-built instruction-voice set correspondence relationship. The first voice set comprises all the voice signals that can trigger the first instruction. When the voice control is performed next time, if the user's voice instruction is the first voice signal, the television can recognize that the user needs to perform the operation of the first instruction, and executes the first instruction after the recognition, finishing the user's voice control procedure.

In such a way, when the television cannot recognize the collected first voice signal, that is, when the television cannot recognize the user's voice instruction, it can display an instruction interface which comprises N instructions. The user can select the first instruction that the television is required to execute as needed. Then, the television executes the first instruction, and stores the first voice signal in the first voice set corresponding to the first instruction according to the pre-built instruction-voice set correspondence relationship such that the user triggers the first instruction once again by the first voice signal. Compared with the known technologies, the voice control function of a television is improved.

For example, before collecting the first voice signal of the user, the television needs to build the instruction-voice set correspondence relationship. The instruction-voice set correspondence relationship is used to indicate the correspondence relationship among the N instructions and N voice sets such that each instruction of the N instructions is corresponding to one voice set. For example, assuming N is 4 and the 4 instructions are “play”, “pause”, “fast forward” and “fast backward” respectively, if “play” is the first instruction, its corresponding voice set is the first voice set, and the first voice set comprises M voice signals, then when the user performs voice control, the voice signal collected by the television is any one voice signal among the M voice signals, and it can trigger the television to perform the action of playing.

Optionally, upon initialization, it is possible to record standard voice signals for N executable instructions of the television. Each voice set of the N voice sets corresponding to the instructions of the television comprises a standard voice signal. In other words, the voice set corresponding to any one instruction comprises one standard voice signal that can trigger the instruction. In general, the standard voice signal is generated by recording in standard Mandarin.

Optionally, before collecting the first voice signal of the user, it is possible to number the N instructions such that each of the instructions is corresponding to one number in order for the user to select the corresponding instruction according to a number.

The method for vocally controlling a television provided by embodiments of the present disclosure first collects a first voice signal of a user, and then determines whether the first voice signal can be recognized. When the television cannot recognize the first voice signal, it displays an instruction interface which comprises N instructions for user to select a first instruction corresponding to the first voice signal, said first instruction being any one instruction among the N instructions. After the user selects the first instruction, the television executes the first instruction and stores the first voice signal in a first voice set corresponding to the first instruction according to the pre-built instruction-voice set correspondence relationship. When the user's voice instruction is the first voice signal next time, the television can recognize that the user needs to perform the operation of the first instruction, and executes the first instruction after the recognition, finishing the user's voice control procedure. Compared with the known technologies, the voice control function of a television is improved.

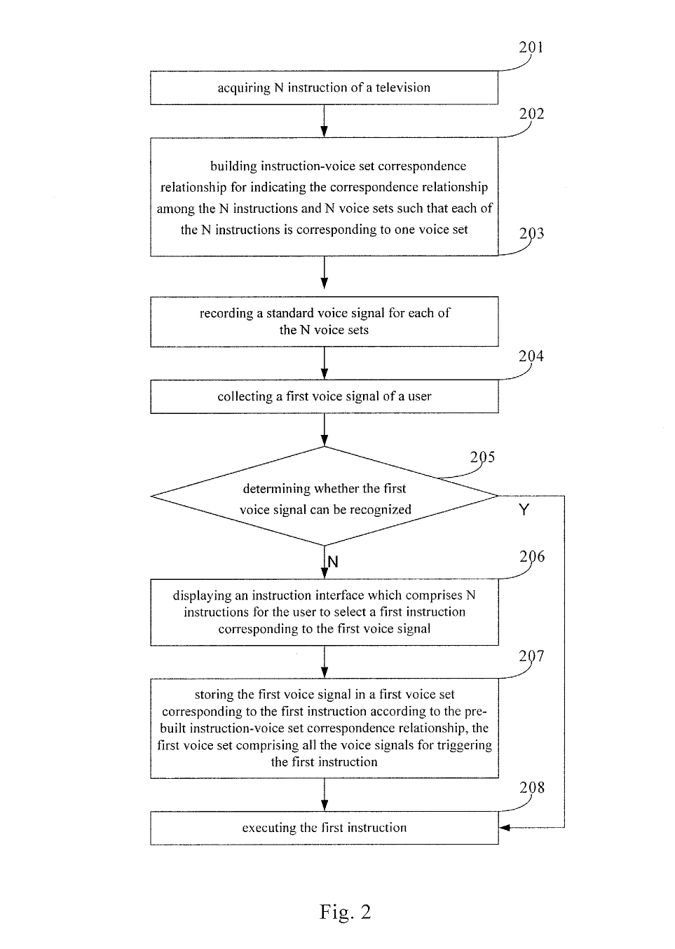

An embodiment of the present disclosure provides a method for vocally controlling a television. As shown in FIG. 2, the method comprises steps 201-208.

At step 201, N instructions of a television are acquired and then step 202 is performed.

With development of the television, normally, the instructions that a television can execute are more and more; therefore, it is first needed to acquire N instructions that the television can execute.

At step 202, instruction-voice set correspondence relationship is built, and then step 203 is performed. The instruction-voice set correspondence relationship is used to indicate the correspondence relationship among the N instructions and N voice sets such that each instruction of the N instructions is corresponding to one voice set.

After acquiring the N instructions of the television, the television needs to configure N voice sets for the N instructions and build the instruction-voice set correspondence relationship. The instruction-voice set correspondence relationship is used to indicate the correspondence relationship among the N instructions and the N voice sets such that each instruction of the N instructions is corresponding to one voice set. For example, assuming N is 4 and the 4 instructions are “play”, “pause”, “fast forward” and “fast backward” respectively, then the television needs to set 4 voice sets corresponding to the 4 instructions respectively. For example, if “play” is a first instruction, its corresponding voice set is a first voice set, and the first voice set comprises M voice signals, then when the user performs voice control, the voice signal collected by the television is any one voice signal among the M voice signals, and it can trigger the television to perform the action of playing.

At step 203, a standard voice signal is recorded for each voice set of the N voice sets, and then perform step 204.

For example, it is possible to record a standard voice signal for each voice set of the N voice sets. For example, Mandarin is used to record a first standard voice signal, and the first standard voice signal is stored in the first voice set. In such a way, when the user uses Mandarin to input a voice instruction, the television can recognize the user's voice instruction, and can execute the corresponding first instruction according to the voice instruction.

At step 204, a first voice signal of a user is collected, and then perform step 205.

When receiving the user's voice control, the television first needs to receive the user's voice instruction. The voice instruction is the first voice signal that the television needs to collect. Since the voice instruction sent by the user of the television can be any language or any dialect, the first voice signal collected by the television can also be any language or any dialect.

At step 205, it is determined whether the first voice signal can be recognized. When the television cannot recognize the first voice signal, step 206 is performed; when the television can recognize the first voice signal, step 208 is performed.

Normally, after the television collects the first voice signal, the television performs voice recognition on the first voice signal. For example, it is possible to use a voice recognition chip such as chip LD3320, chip ASR M08 or the like to perform voice recognition on the first voice signal. The voice recognition process is the same as the known technologies, which will not be described in detail herein.

At step 206, an instruction interface is displayed for the user to select the first instruction corresponding to the first voice signal, and then step 207 is performed. The instruction interface comprises N instructions.

When the television cannot recognize the collected first voice signal, the television can display the instruction interface which can display N instructions. The N instructions are all the executable instructions of the television. In practical applications, the instruction interface can also display M instructions that the user may need and are selected by the television according to the first voice signal, and M is smaller than or equal to N. The user can select the required first instruction from the N instructions displayed by the instruction interface. The first instruction is any one instruction of the N instructions. Normally, the user can use a remote controller to move a to-be-conformed mark to the first instruction, then select the first instruction through a confirm key. Alternatively, it is possible to number all the executable instructions of the television upon initialization, and then the user selects the first instruction by using the number keys of the remote controller to select the number corresponding to the first instruction.

For example, assuming N is 4 and the 4 instructions are “play”, “pause”, “fast forward” and “fast backward” respectively, then the instruction interface displays the 4 instructions of “play”, “pause”, “fast forward” and “fast backward” for the user to select the first instruction corresponding to the first voice signal. It is assumed that the first instruction corresponding to the first voice signal is “play”.

At step 207, according to the pre-built instruction-voice set correspondence relationship, the first voice signal is stored in a first voice set corresponding to the first instruction, and then step 208 is performed. The first voice set comprises all the voice signals for triggering the first instruction.

When the instruction selected by the user is the first instruction, it means that the instruction corresponding to the first voice signal collected by the television is the first instruction. The television stores the first voice signal in a first voice set corresponding to the first instruction. The first voice set comprises all the voice signals that can trigger the first instruction. When the user's voice instruction is the first voice signal next time, the television can recognize that the user needs to perform the operation of the first instruction, and executes the first instruction after the recognition, finishing the user's voice control procedure. For example, when the first instruction selected by the user is “play”, it means that the instruction corresponding to the first voice signal is “play”. The television stores the collected first voice signal in the voice set corresponding to the instruction “play”. When the voice control is performed next time, if the user's voice instruction is the first voice signal, the television can recognize and execute the instruction “play”.

At step 208, the first instruction is executed.

For example, when the television can recognize the collected first voice signal, the first instruction corresponding to the first voice signal can be executed.

The method for vocally controlling a television provided by embodiments of the present disclosure first collects a first voice signal of a user, and then determines whether the first voice signal can be recognized. When the television cannot recognize the first voice signal, the television displays an instruction interface which comprises N instructions for user to select a first instruction corresponding to the first voice signal, said first instruction being any one instruction among the N instructions. After the user selects the first instruction, the television executes the first instruction and stores the first voice signal in a first voice set corresponding to the first instruction according to the pre-built instruction-voice set correspondence relationship. When the user's voice instruction is the first voice signal next time, the television can recognize that the user needs to perform the operation of the first instruction, and executes the first instruction after the recognition, finishing the user's voice control procedure. Compared with the known technologies, the voice control function of a television is improved.

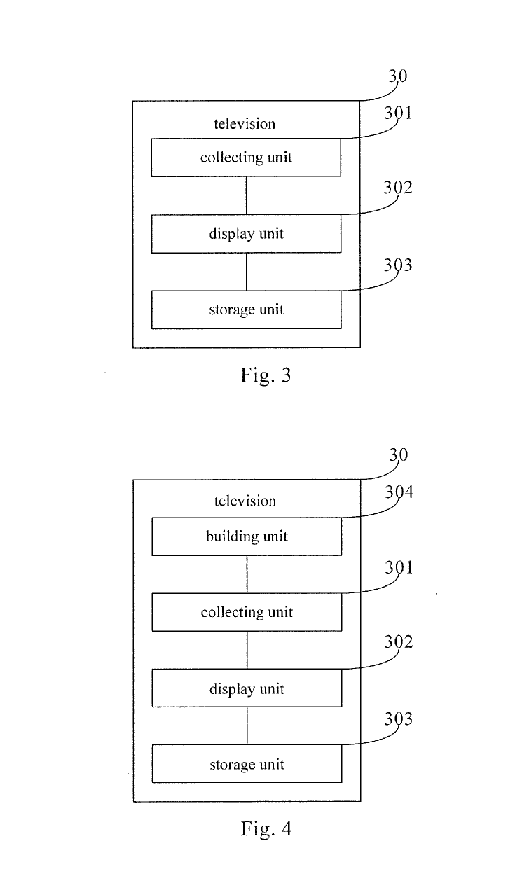

An embodiment of the present disclosure provides a television 30. As shown in FIG. 3, the television comprises:

a collecting unit 301 configured to collect a first voice signal of a user;

a display unit 302 configured to display an instruction interface which comprises N instructions for the user to select a first instruction corresponding to the first voice signal when the television cannot recognize the first voice signal collected by the collecting unit 301, said first instruction being any one instruction among the N instructions; and

a storage unit 303 configured to store the first voice signal collected by the collecting unit 301 in a first voice set corresponding to the first instruction according to the pre-built instruction-voice set correspondence relationship, the first voice set comprising all the voice signals for triggering the first instruction.

In such a way, when the television cannot recognize the collected first voice signal, that is, when the television cannot recognize the user's voice instruction, the display unit can display an instruction interface which comprises N instructions. The user can select the first instruction that the television is required to execute as needed. Then, the television executes the first instruction, and stores the first voice signal in the first voice set corresponding to the first instruction according to the pre-built instruction-voice set correspondence relationship such that the user triggers the first instruction once again by the first voice signal. Compared with the known technologies, the voice control function of a television is improved.

Further, as shown in FIG. 4, the television 30 further comprises the following:

a building unit 304 configured to build the instruction-voice set correspondence relationship for indicating the correspondence relationship among the N instructions and N voice sets such that each instruction among the N instructions is corresponding to one voice set. For example, assuming N is 4 and the 4 instructions are “play”, “pause”, “fast forward” and “fast backward” respectively, if “play” is the first instruction, its corresponding voice set is the first voice set, and the first voice set comprises M voice signals, then when the user performs voice control, the voice signal collected by the television is any one voice signal among the M voice signals, it can trigger the television to perform the action of playing.

Optionally, upon initialization, it is possible to record standard voice signals for N executable instructions of the television. In other words, each of the N voice sets comprises a standard voice signal. The standard voice signal is generated by recording in standard Mandarin.

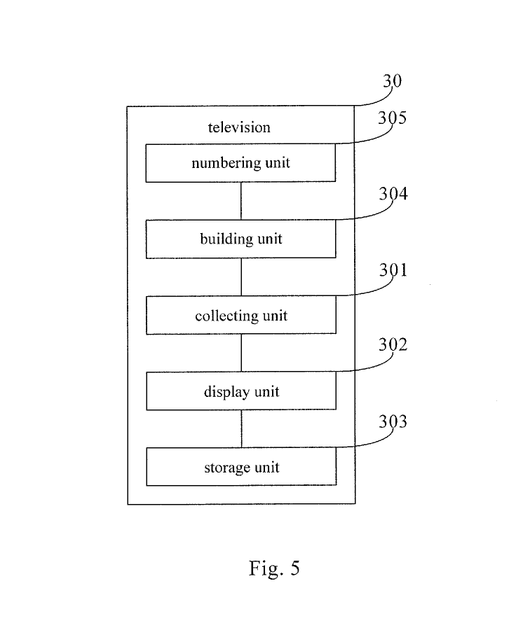

As shown in FIG. 5, the television 30 further comprises a numbering unit 305 configured to number the N instructions such that each of the instructions is corresponding to one number in order for the user to select the corresponding instruction according to a number.

The television provided by embodiments of the present disclosure can first collect a first voice signal of a user, and then determines whether the first voice signal can be recognized. When the television cannot recognize the first voice signal, the television displays an instruction interface which comprises N instructions for the user to select a first instruction corresponding to the first voice signal, said first instruction being any one instruction among the N instructions. After the user selects the first instruction, the television executes the first instruction and stores the first voice signal in a first voice set corresponding to the first instruction according to the pre-built instruction-voice set correspondence relationship. When the user's voice instruction is the first voice signal next time, the television can recognize that the user needs to perform the operation of the first instruction, and executes the first instruction after the recognition, finishing the user's voice control procedure. Compared with the known technologies, the voice control function of a television is improved.

The above descriptions are only exemplary implementations of the present disclosure, but the protection scope of the present disclosure is not limited thereto. Variations and replacements that can be easily devised by those skilled in the art within the technical scope disclosed by the present disclosure should fall within the protection scope of the present disclosure. Therefore, the protection scope of the present disclosure should be defined by the protection scope of the claims.

The present application claims the priority of Chinese Patent Application No. 201410095779.X filed on Mar. 14, 2014, entire content of which is incorporated as part of the present invention by reference.

1. A method for vocally controlling a television, the method being used for the television, comprising steps of:
collecting a first voice signal of a user;
displaying an instruction interface which comprises N instructions for the user to select a first instruction when the television cannot recognize the first voice signal, said first instruction being any one instruction among the N instructions; and
storing the first voice signal in a first voice set corresponding to the first instruction according to the pre-built instruction-voice set correspondence relationship, the first voice set comprising all the voice signals for triggering the first instruction.

2. The method according to claim 1, wherein before collecting the first voice signal of the user, the method further comprises a step of:
building the instruction-voice set correspondence relationship for indicating the correspondence relationship among the N instructions and N voice sets such that each instruction among the N instructions is corresponding to one voice set.

3. The method according to claim 2, wherein each of the voice sets comprises a standard voice signal which is generated by recording in standard Mandarin.

4. The method according to claim 1, wherein the instruction interface displays M instructions that the user may need and are selected by the television according to the first voice signal, and M is smaller than or equal to N.

5. The method according to claim 1, wherein before collecting the first voice signal of the user, the method further comprises a step of:
numbering the N instructions such that each of the instructions is corresponding to one number in order for the user to select the instruction corresponding to a number by inputting the number.

6. A television comprising
a collecting unit configured to collect a first voice signal of a user;
a display unit configured to display an instruction interface which comprises N instructions for the user to select a first instruction when the television cannot recognize the first voice signal collected by the collecting unit, said first instruction being any one instruction among the N instructions; and
a storage unit configured to store the first voice signal collected by the collecting unit in a first voice set corresponding to the first instruction according to the pre-built instruction-voice set correspondence relationship, the first voice set comprising all the voice signals for triggering the first instruction.

7. The television according to claim 6, wherein the television further comprises
a building unit configured to build the instruction-voice set correspondence relationship for indicating the correspondence relationship among the N instructions and N voice sets such that each instruction among the N instructions is corresponding to one voice set.

8. The television according to claim 6, wherein each of the voice sets comprises a standard voice signal which is generated by recording in standard Mandarin.

9. The television according to claim 6, wherein the television further comprises a step of:
a numbering unit configured to number the N instructions such that each of the instructions is corresponding to one number in order for the user to select the instruction corresponding to a number by inputting the number.

10. The method according to claim 1, wherein each of the voice sets comprises a standard voice signal which is generated by recording in standard Mandarin.

11. The method according to claim 2, wherein the instruction interface displays M instructions that the user may need and are selected by the television according to the first voice signal, and M is smaller than or equal to N.

12. The method according to claim 2, wherein before collecting the first voice signal of the user, the method further comprises a step of:
numbering the N instructions such that each of the instructions is corresponding to one number in order for the user to select the instruction corresponding to a number by inputting the number.

13. The method according to claim 3, wherein before collecting the first voice signal of the user, the method further comprises a step of:
numbering the N instructions such that each of the instructions is corresponding to one number in order for the user to select the instruction corresponding to a number by inputting the number.

14. The method according to claim 4, wherein before collecting the first voice signal of the user, the method further comprises a step of:
numbering the N instructions such that each of the instructions is corresponding to one number in order for the user to select the instruction corresponding to a number by inputting the number.

15. The method according to claim 10, wherein before collecting the first voice signal of the user, the method further comprises a step of:
numbering the N instructions such that each of the instructions is corresponding to one number in order for the user to select the instruction corresponding to a number by inputting the number.

16. The television according to claim 7, wherein each of the voice sets comprises a standard voice signal which is generated by recording in standard Mandarin.

17. The television according to claim 7, wherein the television further comprises a step of:
a numbering unit configured to number the N instructions such that each of the instructions is corresponding to one number in order for the user to select the instruction corresponding to a number by inputting the number.

18. The television according to claim 8, wherein the television further comprises a step of:
a numbering unit configured to number the N instructions such that each of the instructions is corresponding to one number in order for the user to select the instruction corresponding to a number by inputting the number.

19. The television according to claim 16, wherein the television further comprises a step of:
a numbering unit configured to number the N instructions such that each of the instructions is corresponding to one number in order for the user to select the instruction corresponding to a number by inputting the number.
